(19) United States
(12) Patent Application Publication
(10) Pub. No.: US 2020/0240309 A1
(43) Pub. Date: Jul. 30, 2020

(54) Connector

(71) Applicant: NORMA Germany GmbH, Maintal (DE)

(72) Inventor: Johan Krona, Kode (SE)

(21) Appl. No.: 16/755,247

(22) PCT Filed: Sep. 19, 2018
(86) PCT No.: PCT/EP2018/075308

§ 371 Date: Apr. 10, 2020

(30) Foreign Application Priority Data
Oct. 11, 2017 (DE) 10 2017 123 606.6

(51) Int. Cl. F01N 3/20; F16L 53/38; F16L 43/00; F16L 39/00

(52) U.S. Cl. CPC F01N 3/2066; F16L 53/38; F16L 43/008; F01N 2610/02; F01N 2610/1486; F01N 2610/10; F16L 39/005

(57) ABSTRACT

The disclosure relates to a connector for two fluid systems which are separated from one another in a liquid-tight manner, comprising a housing which has a first end and a second end, a first channel for a first fluid being formed between the first end and the second end, and a second channel for a second fluid being arranged at least partially inside the first channel, the second channel passing coaxially through the second end. In the region of the first channel, the housing has an outlet portion having an outlet opening through which the second channel exits from the first channel.

The disclosure relates to a connector.

Increasingly stringent requirements for fluid line systems with regard to spatial arrangements and temperature controls of conducted fluids call for ever more compact solutions which can be produced in a simpler and more cost-effective manner.

In particular where urea is used in diesel vehicles which reduce the emission of nitrogen oxides in the exhaust gas, it can be necessary to control the temperature of the fluid because urea crystallizes out already at about −11° C. For controlling the temperature of the urea line at low outside temperature, it is known to provide electrical heating systems which are arranged on or in the urea lines.

An arrangement of this type is shown in EP 2 706 280 B1, wherein a heat conducting element, which is introduced into a fluid line by a connector and can thus control the temperature of the fluid, is provided.

A drawback in this, in some instances, is that the passing fluid can be heated only in the immediate vicinity of the heat conducting element, so that the temperature of the whole solution can be sufficiently controlled only very slowly. Moreover, the production of a connector with a heat conducting element which is introduced into a line in a fluid-tight manner can be complex and cost-intensive.

Also, for the fitting of an electrical heating system on or in a fluid line, there is often a need for additional space, which, in an engine compartment, for instance, is fundamentally very limited.

### SUMMARY

An object of the disclosure, according to an embodiment, is therefore to eliminate the drawbacks of the prior art and to provide a temperature controlling facility for a fluid system, which rapidly controls the temperature of a fluid and is space-saving. Moreover, this temperature controlling facility can be cheap and easy to produce and to fit.

In an embodiment, in a connector for two fluid systems separated from one another in a liquid-tight manner, comprising a housing which has a first end and a second end, wherein a first duct for a first fluid is configured between the first end and the second end and a second duct for a second fluid is arranged at least partially within the first duct, the second duct being directed coaxially through the second end, it is provided that the housing has in the region of the first duct an outlet portion having an outlet opening through which the second duct exits the first duct.

By virtue of the connector according to the disclosure, in an embodiment, a line-in-line system can be provided, whereby the temperature of one fluid can be controlled by the other one. If the first fluid in the first duct is, for instance, coolant liquid, which, during operation of a vehicle, easily reaches 80° C. and more, and the second fluid controls the temperature of a urea solution, for instance, the temperature of this latter is controlled by the coolant liquid and crystallization of urea is effectively prevented. In the abovementioned example, the fluid having the higher temperature serves as frost protection for the fluid having the lower temperature. The first duct connects the first and second end to one other in a fluid-tight manner and such that they can be flowed through.

It is here advantageous that the arrangement requires no additional space, according to an embodiment, but is even space-saving in relation to conventional systems. This is due to the fact that neither is there a need for external heating, nor do two lines have to be directed parallel to one another. Rather, by virtue of the construction of the connector, one fluid line can be integrated into another.

Moreover, the connector is cheap and easy to produce, per an embodiment.

In one embodiment, the first and/or second end have connection geometries. The connector can thereby be connected to other fluid line elements, for instance a hose, a pipe or another connecting element.

Preferably, according to an embodiment, these connection geometries are a connecting branch, which can be connected to a pipe or hose, or a receiving chamber, which can be connected to a counter element. The receiving chamber serves to receive a counter element, for example a quick connector or a plug connector.

In one embodiment, the outlet portion and the outlet opening are arranged in a wall of the first duct. This is often cheap and easy to produce. The second duct for a second fluid is here directed out of the first duct containing a first fluid. Both fluid lines are designed such that they are inherently fluid-tight. Also the outlet portion having the outlet opening from which the second duct exits the first outlet is designed to be fluid-tight. Only the outlet opening enables the passage of the second fluid through the second duct.

It is preferred, according to one embodiment, for the second duct to connect a third and a fourth end to one other. The second duct connects the third and the fourth end to one other such that they are fluid-tight and can be flowed through. The third and/or fourth end here can have connection geometries. This enables the second duct to be connected to other fluid line elements, for instance a hose, a pipe or another connecting element. Preferably, according to an embodiment, these connection geometries are a connecting branch, which can be connected to a pipe, or a receiving chamber, which can be connected to a counter element.

Preferably, according to one embodiment, the third and/or fourth end are arranged on the second duct such that they can be connected to a counter element or a pipe. For instance, that end of the second duct that is arranged coaxially to the second end reaches beyond the interior of the first duct, so that a pipe or hose can be easily slipped on. As a result, the third and fourth end on the second duct are both arranged outside the first duct and the first and second end. This enables a simple installation of the connector within two separate fluid line systems, per this embodiment, wherein the two separate fluid lines are directed onward through the connector as a line-in line system.

Preferably, according to an embodiment, portions of the second duct which are disposed within the first duct are arranged such that they are radially centered, at least in the region of the second end. As a result, an even circulation in the second duct is achieved by the first fluid. This leads to an even flow and to an even control of the temperature of one fluid by the other fluid at the interface of the two fluid systems with one other. The interface is formed by that portion of the second duct that is disposed within the first duct.

Preferably, according to an embodiment, the connection geometry of the first and/or second and/or third and/or fourth end has a circumferential protuberance for connection to a connecting element. The further connecting element can be, for instance, a plug connector. As a result, the connector can be quickly and easily connected to a fluid line.

In one embodiment, the connection geometry of the first and/or second and/or third and/or fourth end has a spike profile. The spike profile can also be referred to as a fir-tree structure, which enables a hose to be easily slipped, with firm fixing thereof, onto the connection geometry. The appropriate connection geometry with a spike profile can be, for instance, a connecting branch.

In one embodiment, the connection geometry of the first and/or second and/or third and/or fourth end has a receiving chamber having locking elements. These locking elements can secure, for instance, a protuberance of a connecting element, or of a connection geometry of a fluid line, in the receiving chamber of the connector.

In one embodiment, between the first duct and the second duct a web is provided, which connects the two ducts to one other. This web stabilizes the arrangement of the second duct within the first duct. In particular, the web connects an inner side of the first duct to an outer side of the second duct. The web is here configured such that the first fluid can flow as evenly as possible through the first duct.

Preferably, according to an embodiment, the connector comprises glass-fiber-reinforced plastic. The connector consists of glass-fiber-reinforced plastic. As a result, the connector is cheap and easy to produce, and stable and durable. Moreover, glass-fiber-reinforced plastic is lighter than a corresponding quantity of metal, whereby weight savings can be made, for instance in the vehicle.

In one refinement, the connector is produced by means of hand lamination processes, milling, transfer molding or 3D printing. In particular, these production methods are used in the processing of glass-fiber-reinforced plastic. The connector can thereby be easily, quickly and cheaply produced.

In one embodiment, the first duct has a curvature, in particular a 90-degree curvature. As a result, the connector is optimally tailored to spatial conditions of an installation space, for instance an engine compartment.

In one alternative embodiment, the first duct is of substantially elongated configuration, without curvature. This too makes it possible to optimally tailor the connector to cramped conditions during the installation process.

### BRIEF DESCRIPTION OF THE FIGURES

Further features, details and advantages of the disclosure emerge from the text of the claims and from the following description of illustrative embodiments with reference to the drawings, wherein:

FIG. 1 shows a lateral sectional view of a connector according to the disclosure,

FIG. 2 shows a top view of the connector in FIG. 1,

FIG. 3 shows a perspective side view of a further embodiment of a connector according to the disclosure.

### DETAILED DESCRIPTION

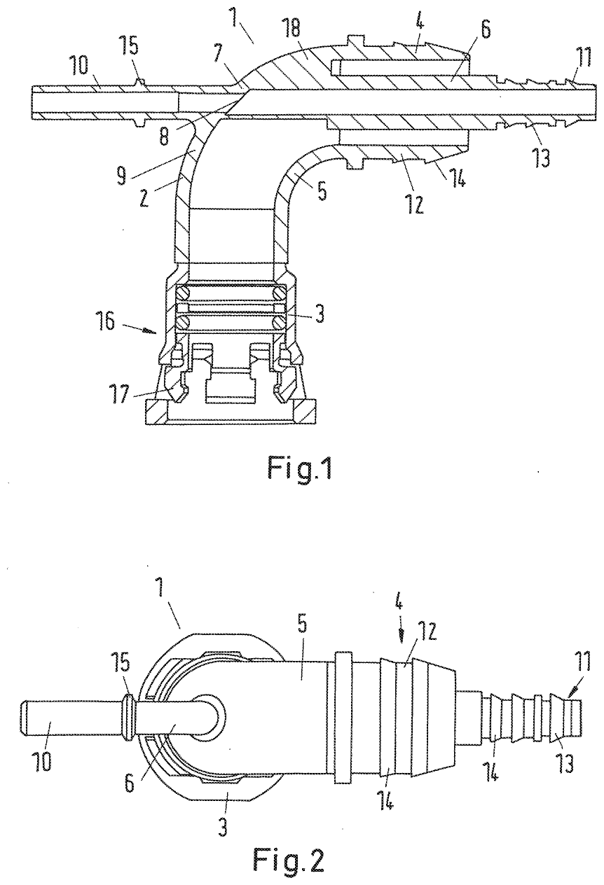

FIG. 1 shows a connector 1 according to the disclosure, comprising a housing 2. The housing 2 has a first end 3 and a second end 4, between which a first duct 5 for a first fluid is configured. A second duct 6 for a second fluid is arranged at least partially within the first duct 5 and exits coaxially through the second end 4. The housing 2 has an outlet portion 7 having an outlet opening 8, through which the second duct 6 exits the housing 2. The outlet portion 7 with the outlet opening 8 is arranged in a wall 9 of the first duct 5.

Through the outlet opening 8 in the outlet portion 7, the second duct 6 for a second fluid is introduced into the first duct 5. A line-in-line system is thereby formed. The fluid systems of the first and second fluid are here configured separate from one another. The arrangement of the first and second duct 5, 6 in the connector is realized such that they are completely fluid-tight and can be flowed through.

The first and second fluid can be both different fluids and the same fluid. The connector 1 can be used for fluid such as, for instance, liquids, solutions and gases.

The second duct 6 connects a third end 10 and a fourth end 11 to one other. The ends 3, 4, 10, 11 serve for the connection of the connector to corresponding fluid lines or further connecting elements. It is therefore provided, in this embodiment, that the ends 3, 4, 10, 11 respectively have a suitable connection geometry.

In FIG. 1, the second end 4 and the fourth end 11 are configured, as connecting branches 12, 13, respectively with a spike profile 14. This enables a hose to be easily slipped onto the appropriate connecting branch 12, 13. The second duct 6 here reaches so far out of the second end 4 of the first duct 5 that the fourth end 11, which is configured as a connecting branch 13, is arranged fully outside the second end. A hose which conducts the second fluid can thereby be easily connected. A second hose can subsequently be slipped onto the connecting branch 12 of the second end, so that the hose for the second fluid is disposed within the hose for the first fluid. The connecting branch 12 of the second end 4 here has a greater diameter than the second duct 6 and the fourth end 11.

In this embodiment, the second duct 6 is arranged such that it is radially centered, at least in the region of the second end 4. As a result, the second duct 6 can be evenly flowed around by the first fluid.

As an alternative connection geometry, a circumferential protuberance 15 is suitable, as is shown in FIG. 1 for the third end 10. The protuberance 15 can be brought into connection with a further connecting element, for instance a plug connector.

A further alternative connection geometry is constituted by a receiving chamber 16 having locking elements 17, as is shown in FIG. 1 for the first end 3. Into the receiving chamber 16 a connecting element can be introduced, for instance with a protuberance. The locking elements then engage behind the connecting element and in this way prevent the connecting element from sliding out of the receiving chamber.

Between the first duct 5 and the second duct 6 a web 18 is additionally provided, which connects the two ducts 5, 6 to one other and thus stabilizes the second duct 6 within the first duct 5.

The connector 1 can be designed such that the first duct 5 has a 90-degree curvature. The second duct 6 can then have a substantially elongated course, without curvature.

FIG. 2 shows a top view of the connector 1 shown in FIG. 1.

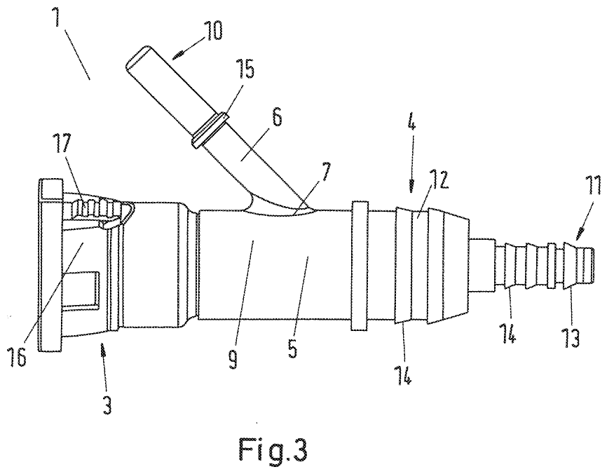

FIG. 3 shows another embodiment of a connector 1 according to the disclosure. Therein, the first duct 5 is of elongated configuration, without curvature. By contrast, the second duct 6 has a curvature which is disposed within the first duct 5. Further features can be identical to the embodiment in FIG. 1.

The invention is not limited to one of the previously described embodiments, but can be modified in a variety of ways.

All features and advantages deriving from the claims, the description and the drawing, inclusive of design details, spatial arrangements and method steps, can be fundamental to the invention both in their own right and in a wide variety of combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### REFERENCE SYMBOL LIST

1 connector

2 housing

3 first end

4 second end

5 first duct

6 second duct

7 outlet portion

8 outlet opening

9 wall of the first duct 5

10 third end

11 fourth end

12 connecting branch at the second end 4

13 connecting branch at the fourth end 11

14 spike profile

15 protuberance

16 receiving chamber

17 locking element

18 web

1. A connector for two fluid systems separated from one another in a liquid-tight manner, comprising a housing which has a first end and a second end, wherein a first duct for a first fluid is arranged between the first end and the second end and a second duct for a second fluid is arranged at least partially within the first duct, the second duct being directed coaxially through the second end, wherein the housing has in the region of the first duct an outlet portion having an outlet opening through which the second duct exits the first duct.

2. The connector as claimed in claim 1, wherein the first end, the second end, or both the first and second ends, have a connection geometry.

3. The connector as claimed in claim 1, wherein the outlet portion and the outlet opening are arranged in a wall of the first duct.

4. The connector as claimed in claim 1, wherein the second duct connects a third and a fourth end to one another.

5. The connector as claimed in claim 4, wherein the third end, the fourth end, or both the third and fourth ends, have a connection geometry.

6. The connector as claimed in claim 1, wherein portions of the second duct which are disposed within the first duct are arranged such that they are radially centered, at least in the region of the second end.

7. (canceled)

8. (canceled)

9. (canceled)

10. The connector as claimed in claim 1, wherein between the first duct and the second duct a web is provided, which connects the two ducts to one another.

11. The connector as claimed in claim 1, wherein the connector comprises glass-fiber-reinforced plastic.

12. The connector as claimed in claim 1, wherein the first duct has a curvature.

13. The connector as claimed in claim 10, wherein the second duct is of substantially elongated configuration.

14. The connector as claimed in claim 2, wherein the connection geometry of the first and/or second ends has a circumferential protuberance for connection to a connecting element.

15. The connector as claimed in claim 5, wherein the connection geometry of the third and/or fourth ends has a circumferential protuberance for connection to a connecting element.

16. The connector as claimed in claim 2, wherein the connection geometry of the first and/or second ends has a spike profile.

17. The connector as claimed in claim 5, wherein the connection geometry of the third and/or fourth ends has a spike profile.

18. The connector as claimed in claim 2, wherein the connection geometry of the first and/or second ends has a receiving chamber having locking elements.

19. The connector as claimed in claim 5, wherein the connection geometry of the third and/or fourth ends has a receiving chamber having locking elements.

20. The connector as claimed in claim 12, wherein the curvature is a 90 degree curvature.
